(19) United States
(12) Patent Application Publication
(10) Pub. No.: US 2023/0419230 A1
(43) Pub. Date: Dec. 28, 2023

(54) SALES ACTIVITY SUPPORT APPARATUS AND SALES ACTIVITY SUPPORT METHOD

(71) Applicant: Hitachi, Ltd., Tokyo (JP)

(72) Inventor: Masahiro HOSOKAWA, Tokyo (JP)

(73) Assignee: Hitachi, Ltd., Tokyo (JP)

(21) Appl. No.: 18/115,061

(22) Filed: Feb. 28, 2023

(30) Foreign Application Priority Data
Jun. 28, 2022 (JP) 2022-103645

(51) Int. Cl. G06Q 10/0639

(52) U.S. Cl. CPC G06Q 10/06393

(57) ABSTRACT

A sales activity support apparatus 100 is configured including a storage device 101 that holds pieces of information on a sales target organization and a sales activity and an arithmetic device 104 that calculates a predicted value of a KPI by applying information in the pieces of information other than part of the pieces of information to a KPI prediction model, calculates a weight corresponding to a degree by which the predicted value exceeds a track record value for the sales activity, generates a policy value determination model through learning based on the organization information, the KPI, and the weight, determines the policy value by applying the organization information to the determination model, determines an unweighted policy value by applying the organization information to a determination model learned with no weight applied, and outputs them.

### CROSS-REFERENCE TO RELATED APPLICATION

This application claims priority pursuant to Japanese patent application No. 2022-103645, filed on Jun. 28, 2022, the entire disclosure of which is incorporated herein by reference.

### BACKGROUND

### Technical Field

The present disclosure relates to a sales activity support apparatus and a sales activity support method.

### Related Art

A sales representative's sales performance is greatly affected by the suitability of an activity policy for conducting a sales activity, such as which criteria to follow to determine where to pay a visit or which product to propose. Thus, there have been various prior arts for determining the direction of the sales activities.

For example, a sales activity support apparatus and a sales activity support method for enabling a sales representative to conduct sales activities efficiently at appropriate timing by generating a sales activity plan using cancellation prediction has been proposed (see Japanese Patent Application Publication No. 2021-64406).

This technique relates to a sales activity support apparatus including an analysis prediction part that uses contracted client information to predict the rates of future cancellation by the contracted clients, a continuance tendency pattern generation part that generates a continuance tendency pattern list indicating analysis target conditions corresponding to contracted clients with low rates of future cancellation predicted by the analysis prediction part, and a sales activity plan generation part that identifies, in uncontracted client information, a client that meets the analysis target conditions indicated by the continuance tendency pattern list generated by the continuance tendency pattern generation part and generates a sales activity plan describing a sales activity suitable for the uncontracted client thus identified.

Also, for example, a BtoB solution sales scoring system capable of calculating the rate of matching of a subject to BtoB solution sales even if the subject has never experienced BtoB solution sales before has been proposed (see Japanese Patent Application Publication No. 2022-30099).

This technique relates to a BtoB solution sales scoring system including a calculation part that calculates the rate of matching of a subject to BtoB solution sales, the system further including an assessment result storage part that stores results of assessment of a salesperson's BtoB solution sales skills in the past, a backbone storage part that stores the backbone of the salesperson in the past, a track record data storage part that stores track record data on sales cases of which the salesperson in the past was in charge, and an input part that inputs results of assessment of a subject's BtoB solution sales skills and the backbone of the subject, in which the calculation part calculates the rate of matching of the subject to BtoB solution sales using the assessment results, backbone, and track record data of the salesperson in the past and the assessment results and backbone of the subject.

Also, for example, a sales support system that calculates a state from a history of sales daily reports related to a specified sales target and recommends an action with a high score of expectation for future profit under this state has been proposed (see Japanese Patent Application Publication No. 2020-123183).

This technique relates to a sales support system that manages sales daily reports each stating the type of action related to a sales activity performed by a sales representative, time information on the time when the action was performed, a sales target for which the action was performed, and information on the sales progress observed as a result of the action, the sales support system including: state calculation means that calculates a status variable indicative of a sales progress from a history of the sales daily reports related to a specified sales target; action value function storage means that stores an action value function for calculating action value indicative of a value of expectation of future profit to be brought by an action that a sales representative can perform under a certain state; recommendation means that calculates action value of each action that a sales representative can perform under the current state calculated by the state calculation means based on the action value function stored in the action value function storage means and recommends an optimal action based on the action value calculated; action calculation means that calculates the type of action performed by a sales representative from the history of the sales daily reports related to the specified sales target; reward calculation means that calculates a reward indicative of the immediate evaluation of the action performed by the sales representative from the history of the sales daily reports related to the specified sales target; and learning means that updates the action value function stored in the action value function storage means through reinforcement learning based on the state calculated by the state calculation means, the action calculated by the action calculation means, and the reward calculated by the reward calculation means.

Conventionally, supervised learning has been widely used as an algorithm defining sales activity policies. In this case, a model is generated using, as learning data, the contents and track records of past sales activities, and various pieces of information on a determination target are fed to this model to predict a suitable sales activity policy, i.e., a future, predicted as an extension of the past.

If there is a reasonable quantity of past track record data, prediction is indeed possible at a certain level of accuracy, but considering the nature and goals of sales activities, it is not always a preferable mode of prediction.

For example, if a sales representative only proposes a usual product to an existing client, a burden on the sales representative is small, and also, sales performance similar to what it was before can be expected. However, it is hard to expect that their track records will be expanded and deepened by new client development and new product proposals.

Meanwhile, increasing activities intended for new client development in a blind way may only increase burdens on sales representatives and may rather lower their sales performance in a short run. Thus, if a sales representative is presented with a policy made just with an intension for new client development, it is difficult for them to reflect the policy as is in their own actions.

### SUMMARY

Thus, the present disclosure has an object to provide a technique capable of generating and presenting a recommended measure about a sales activity which makes sense to a sales representative and with which a reasonable success, including new client development, can be expected.

A sales activity support apparatus of the present disclosure to solve the above object comprising: a storage device configured to hold pieces of information on a sales target organization and a sales activity for the organization; and an arithmetic device configured to execute processing to calculate a predicted value of a KPI about the organization by applying information to a predetermined KPI prediction model obtained through learning based on part of the pieces of information, the information applied to the predetermined KPI prediction model being information in the pieces of information other than the part of the pieces of information, processing to calculate a weight corresponding to a degree by which the predicted value exceeds a track record value related to the sales activity for the organization, processing to generate a determination model for determining a policy value indicating direction of a sales activity related to the organization, the determination model being generated through learning based on the information on the organization as an explanatory variable, the KPI related to the sales activity for the organization, and the weight, processing to determine the policy value by applying the information on the organization to the determination model, processing to determine an unweighted policy value by applying the information on the organization to a determination model which is the determination model learned with no weight applied, and processing to output the policy value and the unweighted policy value obtained about the organization.

A sales activity support method of the present disclosure implemented by an information processing apparatus, comprising: holding, in a storage device, pieces of information on a sales target organization and a sales activity for the organization; and executing processing to calculate a predicted value of a KPI about the organization by applying information to a predetermined KPI prediction model obtained through learning based on part of the pieces of information, the information applied to the predetermined KPI prediction model being information in the pieces of information other than the part of the pieces of information, processing to calculate a weight corresponding to a degree by which the predicted value exceeds a track record value related to the sales activity for the organization, processing to generate a determination model for determining a policy value indicating direction of a sales activity related to the organization, the determination model being generated through learning based on the information on the organization as an explanatory variable, the KPI related to the sales activity for the organization, and the weight, processing to determine the policy value by applying the information on the organization to the determination model, processing to determine an unweighted policy value by applying the information on the organization to a determination model which is the determination model learned with no weight applied, and processing to output the policy value and the unweighted policy value obtained about the organization.

The present disclosure can generate and present a recommended measure about a sales activity which makes sense to a sales representative and with which a reasonable success, including new client development, can be expected.

### BRIEF DESCRIPTION OF THE DRAWINGS

FIG. 1 is a configuration diagram of a system including a sales activity support apparatus of the present embodiment.

FIG. 2 is a diagram showing an example hardware configuration of the sales activity support apparatus of the present embodiment.

FIG. 3 is a diagram showing an example configuration of a company DB in the present embodiment.

FIG. 4 is a diagram showing an example configuration of a product DB in the present embodiment.

FIG. 5 is a diagram showing an example configuration of a track record DB in the present embodiment.

FIG. 6 is a diagram showing an example concept of a sales activity support method of the present embodiment.

FIG. 7 is a diagram showing an example flowchart of the sales activity support method of the present embodiment.

FIG. 8 is a diagram showing an example table image for first learning in the present embodiment.

FIG. 9 is a diagram showing an example of weight calculation in the present embodiment.

FIG. 10 is a diagram showing an example of a decay parameter in the present embodiment.

FIG. 11 is a diagram showing an example concept of second learning in the present embodiment.

FIG. 12 is a diagram showing an example of a list of policies outputted in the present embodiment.

FIG. 13 is a diagram showing an example of a policy graph outputted in the present embodiment.

### DETAILED DESCRIPTION OF THE INVENTION

### <Background and Concept as Premises>

First, a description is given of an overview of problems and solutions that the Applicants have found in regards to the present disclosure. As already described, a sales representative's sales performance is greatly affected by the suitability of an activity policy for conducting a sales activity, such as which criteria to follow to determine where to pay a visit or which product to propose.

Thus, ideas already exist of creating a model for exploring a sales policy through reinforcement learning performed by feeding attributes of past sales activities and target companies and sales track records to a learning engine. However, a sales policy presented by such a model based on reinforcement learning is not always the best measure. This is because such a policy also includes exploratory activities for maximizing future value.

When such exploratory sales activities increase, sales track records do not improve in a short run, and value (a key performance indicator (KPI) may become lower than at present. Thus, the degree of such exploratory activities may be a matter to be adjusted based on a business decision. Thus, it is necessary to know how much of the sales policies presented to the sales representative as recommended measures based on the results of reinforcement learning are exploratory measures, but this is difficult with the existing techniques.

Also, when results of reinforcement learning are used for activities like sales activities that involve human actions (such as decision making and paying visits), it is unlikely that a sales representative feels right about, accepts, and conducts the policy adjusted in priority by reinforcement learning.

Conducting such a policy tends to affect sales performance, and therefore, the sales representative tends not to perform the policy unless they find that the policy is adequate and makes sense. In other words, an additional measure is needed in order to increase the execution rate of such a policy.

Whether the policy makes sense to the sales representative depends on whether the discrepancies are small between the policy and their knowledge and activities in the past. However, in a phase where it is necessary to make a change in actions for sales activities, policies that are different from the past activities by the sales representative are presented, and hence, there is a tendency that it is difficult to gain understanding from the sales representative.

Thus, in the present disclosure, sales activities performed by a sales representative thus far (activities that the sales representative finds effective+activities determined to be effective by conventional systems) and the new direction of sales activities found by the present system are mixed and proposed with their balance adjusted appropriately.

Specifically, an algorithm involving (1) predicting sales track records as an extension of the past using data in the past, (2) identifying upward deviation of track record values as seen from results of this prediction (i.e., an extension of the past), (3) preferentially presenting an action with the upward deviation by weighing the action is executed and modeled by reinforcement learning.

Also, assumed as a KPI to be considered in this modeling is, for example, a part changed (increased) by an action among results attained by sales activities (such as new sales and client acquisition). To maximize this KPI, it is necessary to appropriately select targets of sales activities such as a company to initiate a contact with for business and a product to propose to such a company, and present such targets to the sales representative.

According to the present disclosure, the positioning (going aggressive, going defensive, moving back, or waiting) of each policy presented to a sales representative as a recommended measure is shown explicitly so that the sales representative can effortlessly understand the point of the policy and link it to their actual sales activities. Also, in doing so, the sales representative can know the tendency of their own activities in the past (e.g., they tend to be aggressive).

### <System Configuration>

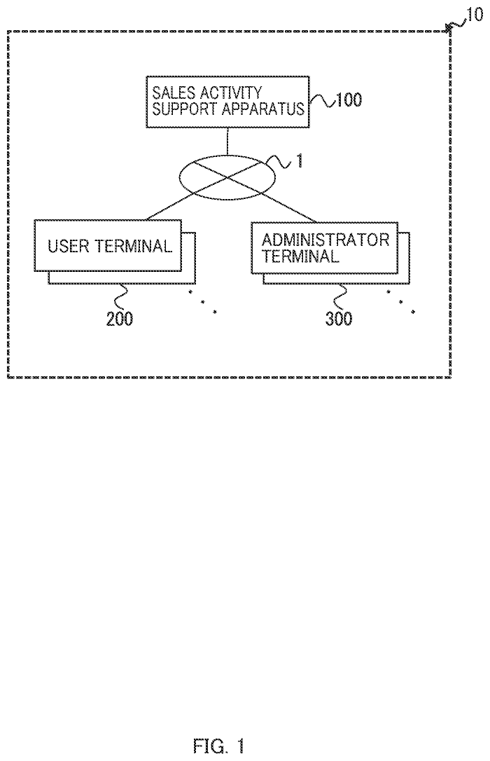

An embodiment of the present disclosure is described in detail below using the drawings. FIG. 1 is a diagram of the configuration of a system including a sales activity support apparatus 100 of the present embodiment. The sales activity support apparatus 100 shown in FIG. 1 is a computer that makes it possible to generate and present a recommended measure about a sales activity which makes sense to a sales representative and with which a reasonable success, including new client development, can be expected.

For example, the sales activity support apparatus 100 of the present embodiment is, as shown in FIG. 1, communicatively coupled to user terminals 200 each operated by a sales representative and administrator terminals 300 each operated by a director or the like that supervises sales activities, via a network 1 such as the Internet and a local area network (LAN). Thus, they can be collectively called a sales activity support system 10.

Meanwhile, the user terminal 200 is a terminal that a sales representative as described above uses to use a service provided by the sales activity support apparatus 100. Specific possible examples include a smartphone, a tablet terminal, and a personal computer.

Also, the administrator terminal 300 is a terminal that a director or the like as described above uses to use a service provided by the sales activity support apparatus 100, and is a terminal used to provide the sales activity support apparatus 100 with various kinds of data for model creation (data in a company DB 125, a product DB 126, and a track record DB 127). Specific possible examples include a smartphone, a tablet terminal, and a personal computer.

### <Hardware Configuration>

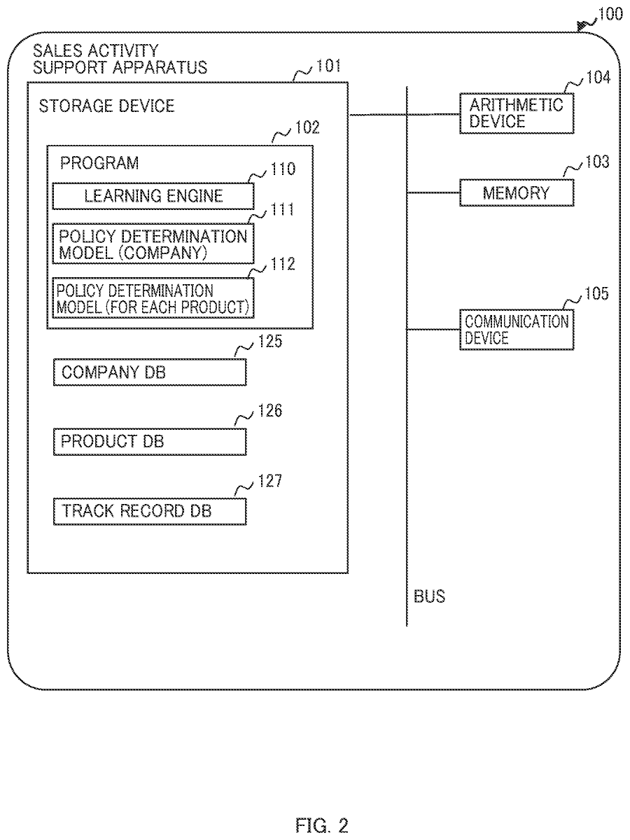

The hardware configuration of the sales activity support apparatus 100 of the present embodiment is as shown in FIG. 2 and described below. Specifically, the sales activity support apparatus 100 includes a storage device 101, a memory 103, an arithmetic device 104, and a communication device 105.

The storage device 101 is formed of an appropriate nonvolatile storage element such as a solid-state drive (SSD) or a hard disk drive.

The memory 103 is formed of a volatile storage element such as a random-access memory (RAM).

The arithmetic device 104 is a CPU that performs overall control of the apparatus and also performs various kinds of determination, computation, and control processing by, e.g., reading a program 102 stored in the storage device 101 into the memory 103 and executing the program 102.

Note that the program 102 includes a learning engine 110 for performing reinforcement learning (including a concept of machine learning), a prediction model 111, a policy determination model (client) 112, and a policy determination model (for each product) 113 generated through the learning by the learning engine 110. As an algorithm for and operation of this model generation by the learning engine 110, existing ones may be used appropriately.

A device assumed here as the communication device 105 is, e.g., a network interface card coupled to the network 1 to perform processing for communications with the user terminals 200 and the administrator terminals 300.

Note that if the sales activity support apparatus 100 is a stand-alone machine, it is preferable to further include an input device for receiving key input or voice input from a user and an output device such as a display for displaying processing data.

Also, the storage device 101 stores not only the program 102 for implementing functions necessary as the sales activity support apparatus of the present embodiment, but also at least the company DB 125, the product DB 126, and the track record DB 127. Details of these databases will be described later.

### <Example Data Structures>

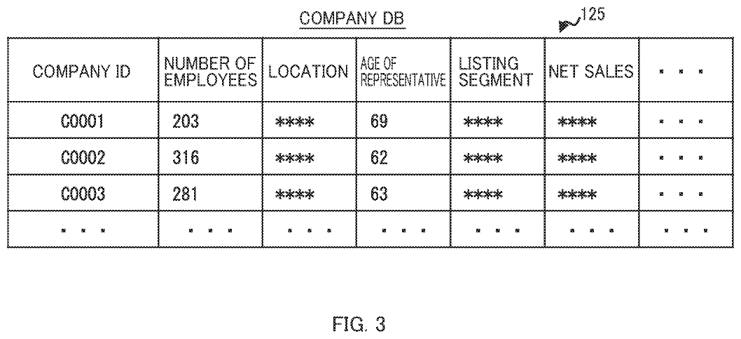

Next, various kinds of information used by the sales activity support apparatus 100 of the present embodiment are described. FIG. 3 shows an example of the company DB 125 of the present embodiment.

The company DB 125 of the present embodiment is a database storing various kinds information about each of companies that are potential targets for sales activities. This company DB 125 is, for example, a collection of records in which a company ID, which uniquely identifies a company and serves as a key, is linked to its corresponding data such as the number of employees, location, the age of the representative, listing segment, and net sales.

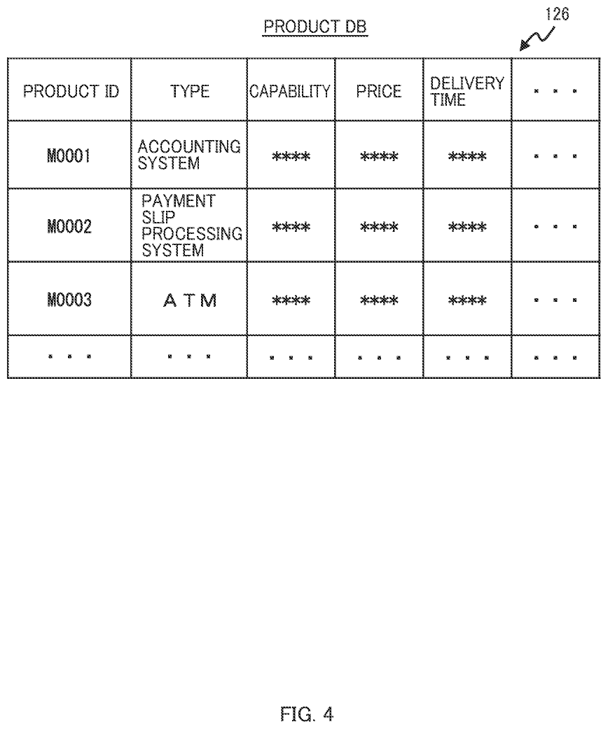

FIG. 4 shows an example configuration of the product DB 126 of the present embodiment. The product DB 126 of the present embodiment is a database storing information on products that can be proposed to a sales target company as a product to be sold by sales activities.

This product DB 126 is, for example, a collection of records in which a product ID, which uniquely identifies a product and serves as a key, is linked to its corresponding data such as type, capability, price, and delivery time.

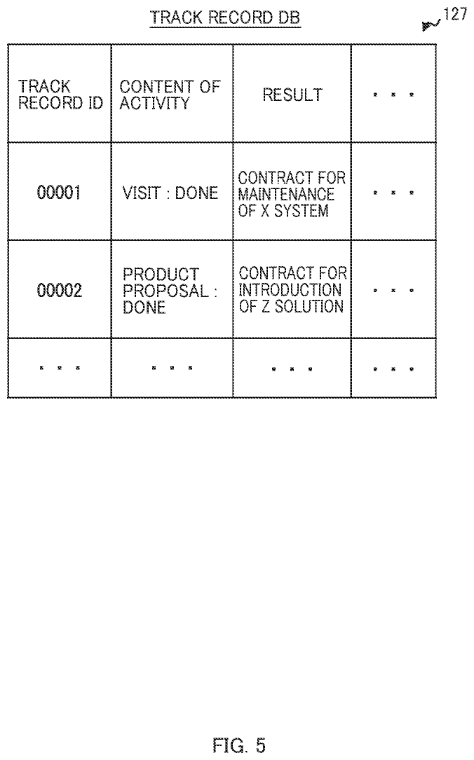

FIG. 5 shows an example configuration of the track record DB 127 of the present embodiment. The track record DB 127 of the present embodiment is a database storing information related to results of sales activities.

This track record DB 127 is, for example, a collection of records in which a track record ID, which uniquely indicates a track record and serves as a key, is linked to its corresponding data such as content of each sales activity (ex: whether a visit was paid to a potential customer or whether a product was proposed) and a result of the activity (ex: a contract for a product, a sales history, etc.).

### <Example Flowchart>

An actual procedure of the sales activity support method of the present embodiment is described below based on the drawings. Various operations in the sales activity support method described below are implemented by a program that the sales activity support apparatus 100 reads into memory or the like and executes. This program is formed by code for performing various operations to be described below.

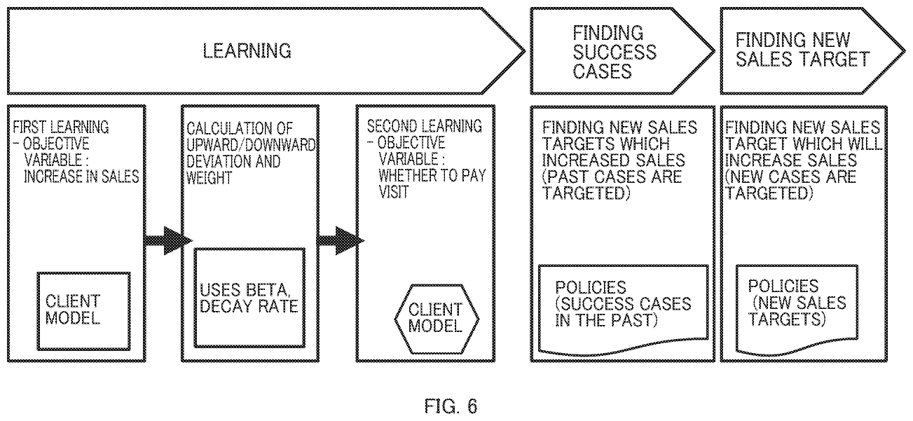

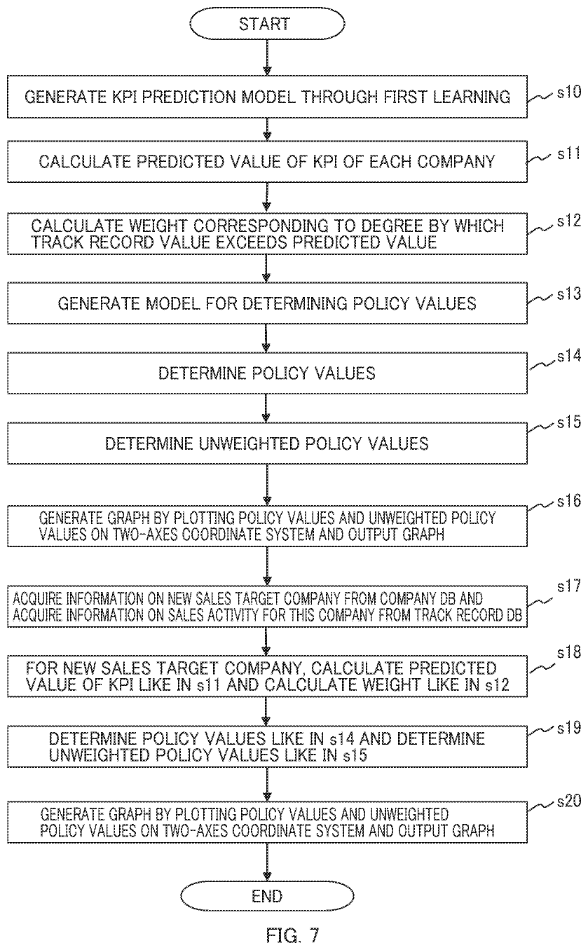

FIG. 6 is a diagram showing an example concept of the sales activity support method of the present embodiment, and FIG. 7 is a diagram showing an example flowchart of the sales activity support method of the present embodiment. A situation assumed in this case is, as outlined in FIG. 6, a business flow like generating models through first learning and second learning, outputting policy values using them, finding success cases in the past, and finding a new sales target.

Thus, the sales activity support apparatus 100 performs reinforcement learning by feeding learning data to the learning engine 110, the learning data being part of the above-described information in the company DB 125, which has information on organizations, and the product DB 126 and the track record DB 127, which have information on sales activities, and generates, for example, a prediction model for determining a KPI indicative of “a state of having business with many customers for a variety of products” (s10).

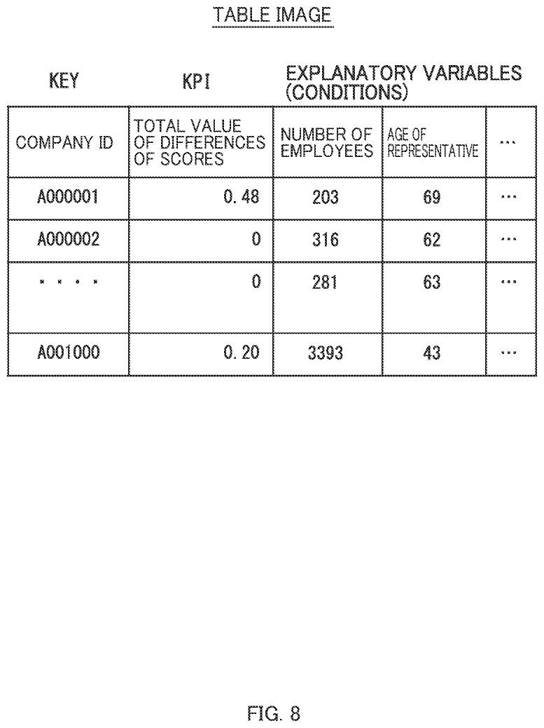

FIG. 8 shows, as a table image, an example of explanatory variables extracted from the company DB 125 and the product DB 126 and KPIs extracted from the track record DB 127 in this case.

Through the first learning, prediction models are created, and predicted values are calculated in order to observe an upward deviation (a part where a track record value exceeds the predicted value). In the prediction model creation, for example, two datasets are made, and two prediction models are created.

Also, in the calculation of the predicted values, predicted values are calculated of datasets not used in the learning of any of the models, and the predicted values are combined together and used for “CALCULATION OF UPWARD/DOWNWARD DEVIATION AND WEIGHT” Because data not used for the learning is used to calculate the predicted values, overtraining can be reduced.

The sales activity support apparatus 100 calculates a predicted value of a KPI for each of companies by applying information in the pieces of information other than the part of the information, i.e., information not used for the prediction model generation, to the prediction models generated above (s11).

Also, the sales activity support apparatus 100 refers to the track record DB 127 for track record values for sales activities conducted for the above-described companies and calculates weights corresponding to the degrees by which the track record values exceed the respective predicted values (s12).

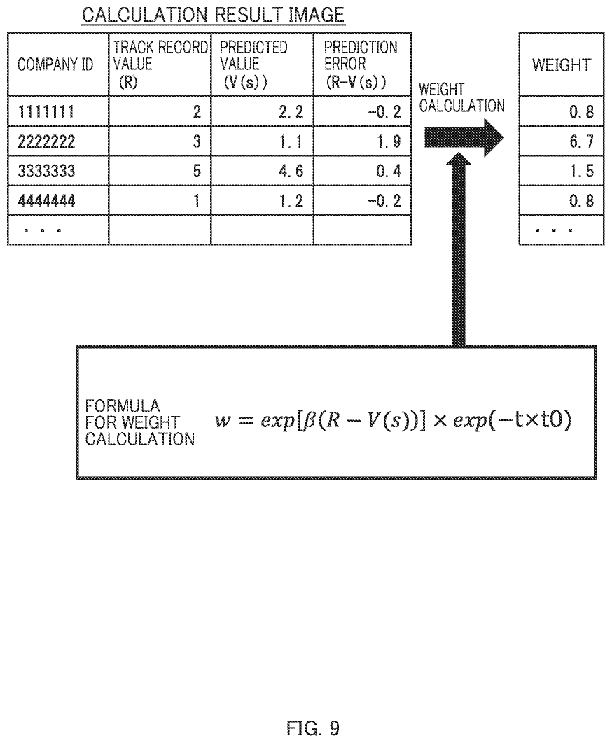

FIG. 9 shows an example of the process and results of the processing in s11 and s12 described above. The calculation result image shown in FIG. 9 shows an example of track record values about sales activities referred to about the respective companies (company IDs: 1111111 to 4444444), predicted values of KPIs calculated in s11, and errors which are differences between them. Also, weights are calculated for the respective companies based on the errors.

Note that these weights are such that past data is decayed by a decay rate so as to put more value on recent activities than on past activities. FIG. 9 also shows a calculation formula for such weights, where R is a track record value, V(s) is a predicted value, w is a weight, β is a tuning parameter, t is a cycle number, and t0 is a decay parameter.

Also, tuning of a weight by β is such that lowering β makes the weight smaller, which consequently means not to increase the importance on a company that shows an upward deviation result. Then, this reduces motivation for new client exploration and produces fewer fruitless sales activities, but then, exploration of new sales targets is less likely to progress. By contrast, raising β makes the weight large, which consequently means to increase the importance on a company that shows an upward deviation result. Then, this increases motivation for new client exploration and produces more fruitless sales activities, but then, exploration of new sales targets is more likely to progress.

Note that an optimum decay rate (exp(−t×t0)) differs depending on whether the size of a market change in a market to which a company or product as a target of sales activities belongs is large or small. Thus, an evaluation of the size of a market change is made in order to determine the decay parameter (t0).

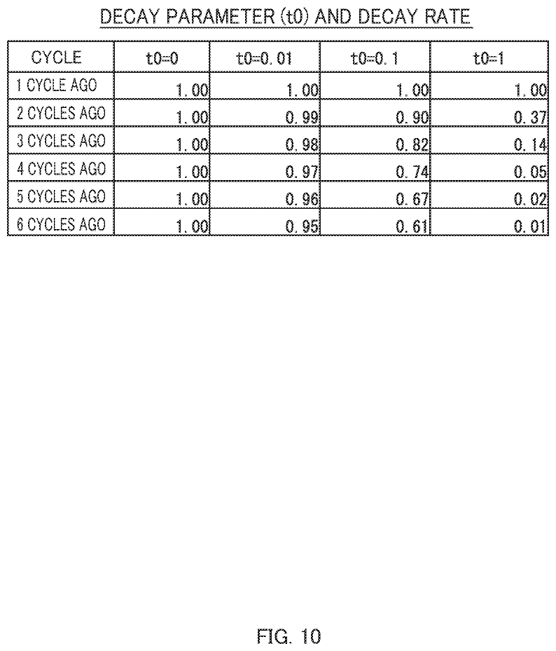

As the relation between the decay parameter (t0) and the decay rate shown in FIG. 10 indicates, when the decay parameter (t0) is changed, the decay rate for each cycle changes as well. Thus, the sales activity support apparatus 100 determines the market change by applying, to a predetermined rule, variation and changes in an order receipt rate (order receipt rate=the number of orders received/the number of proposals) in past data indicated by the track record DB 127.

For example, if it is determined that the market experiences ups and downs repeatedly in a short period, the sales activity support apparatus 100 determines that a cycle corresponding to the “short period of time” is appropriate as a cycle for the decay parameter (t0).

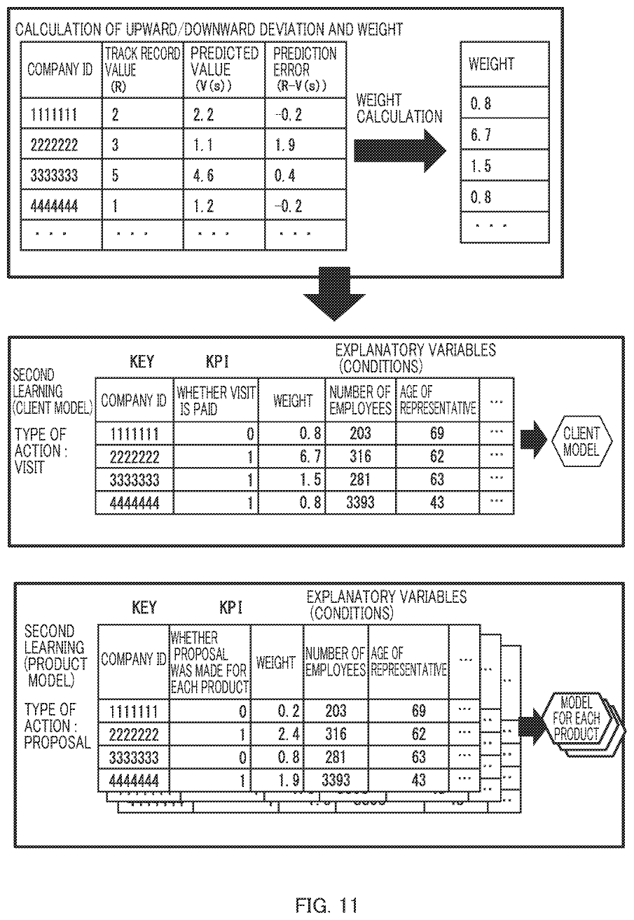

Next, the sales activity support apparatus 100 feeds the above-described pieces of information on the companies, which are explanatory variables, KPIs related to sales activities conducted for the companies (ex: whether a visit was made, whether a product was proposed), and the weights calculated in s12 described above to the learning engine 110 to train the learning engine 110, thereby generating models for determining policy values indicating the directions of the sales activities related to the companies (s13). As the models generated here, the policy determination model (client) 112 based on actions for companies and the policy determination model (for each product) 113 based on actions for each product are both assumable (see FIG. 11).

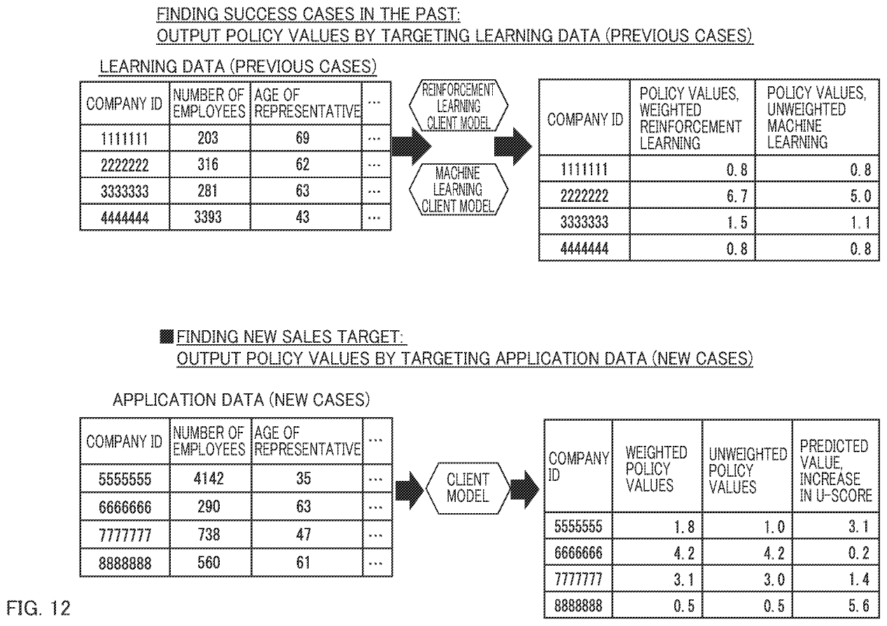

Next, the sales activity support apparatus 100 applies the above-described company information to, for example, the policy determination model (client) 112 (reinforcement learning client model) and determines policy values (s14). The sales activity support apparatus 100 also applies the above-described company information to a determination model (machine learning client model) in which no weights are applied in the training of the policy determination model and determines unweighted policy values (s15). A specific concept for this calculation is exemplified in the upper part of FIG. 12 as “FINDING SUCCESS CASES IN THE PAST.”

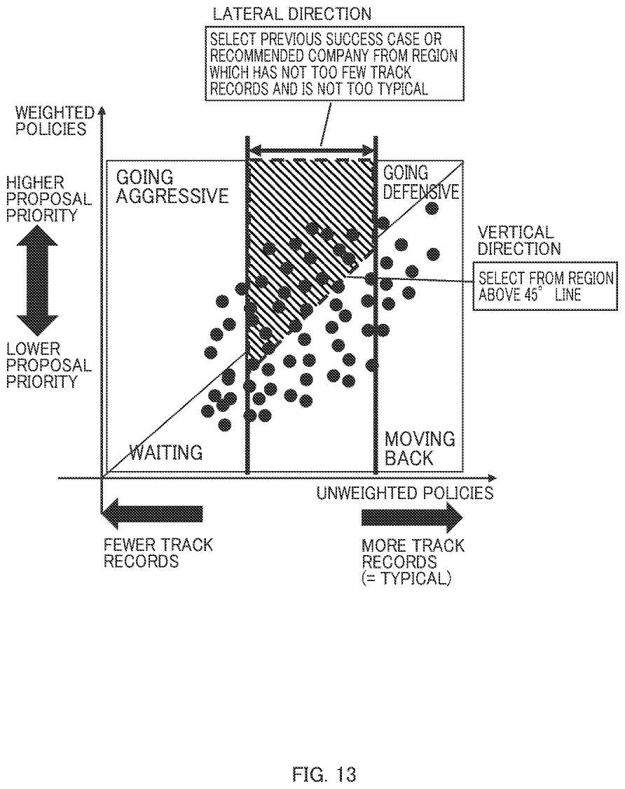

Also, the sales activity support apparatus 100 generates a graph by plotting the policy values obtained in s14 and the unweighted policy values obtained in s15 described above on a coordinate system with two axes corresponding to policy values and unweighted policy values, like the graph shown in FIG. 13 as an example, and outputs the graph (s16). The flowchart may end here, but in this example, the following processing is executed next in response to a user specification or the like.

In this case, the sales activity support apparatus 100 acquires information on a company as a new sales target from the company DB 125 and information on a sales activity for the company from the track record DB 127 (s17).

Also, based on the information acquired in s17, the sales activity support apparatus 100 performs the calculation of a predicted value of the KPI like in s11 described above and the calculation of a weight like in s12 described above, concerning the new sales target company (s18).

Also, the sales activity support apparatus 100 performs the determination of policy values like in s14 and the determination of unweighted policy values like in s15, concerning the new sales target company (s19).

Also, the sales activity support apparatus 100 outputs a graph generated by plotting the policy values and the unweighted policy values acquired concerning the new sales target company like in s16 (s20) and ends the processing.

As shown in the graph in FIG. 13, a region is set in this coordinate system with two axes. This region is outside regions with too few past track records like the regions at the left and right ends (near “going aggressive,” “waiting,” “going defensive,” and “moving back”), is not too typical because there are a reasonable number of past track records (the unweighted policy values are within a predetermined range of the whole, which may be set appropriately according to data or the company's intension), and has a high degree of upward track record deviation (a region above the 45° line on the coordinate system). When policy values of past cases are plotted, companies included in this region are success cases in the past, and when policy values for new cases are plotted, companies included in this region are recommended new sales targets.

The best mode and the like for carrying out the present disclosure have been described specifically above; however, the present disclosure is not limited to this and may be variously modified without departing from the gist thereof.

According to the present embodiment, the level of effort put toward new client development (the level of exploration) in sales activities is visualized appropriately, and recommended measures can be proposed to a sales representative explicitly in an easy-to-understand manner along with the positioning of the measures (going aggressive, going defensive, moving back, and waiting). It is also possible to present the tendency of past sales activities by each individual sales representative (ex: a tendency to be aggressive) in an easy-to-understand manner.

By extension, it is possible to generate and present a recommended measure about a sales activity which makes sense to a sales representative and with which a reasonable success, including new client development, can be expected.

The descriptions herein demonstrate at least the following matters. In other words, the sales activity support apparatus according to the present embodiment, wherein in the output of the policy value and the unweighted policy value, the arithmetic device may generate a graph by plotting the policy value obtained for each organization on a coordinate system corresponding to the policy value and the unweighted policy value and may output the graph.

According to this, the direction of sales activities can be explicitly presented based on a good balance between whether there are a large or small number of track records of sales activities for each organization and the degrees of upward deviations of the track records (relative to the prediction) for the organization. By extension, it is possible to generate and present a recommended measure about a sales activity which makes more sense to a sales representative and with which a reasonable success, including new client development, can be expected.

The sales activity support apparatus according to the present embodiment, wherein the arithmetic device may acquire pieces of information on a new sales target organization and on a sales activity for the new sales target organization, may perform the calculation of a predicted value of the KPI and the calculation of the weight for the new sales target organization, may perform the determination of each of the policy value and the unweighted policy value about the new sales target organization, and may output the policy value and the unweighted policy value obtained about the new sales target organization.

According to this, a sales representative can contemplate the direction of sales activities for an organization to develop new business with, based on a good balance between whether there are a large or small number of track records of sales activities and the degrees of upward deviations of the track records for the organization. By extension, it is possible to generate and present a recommended measure about a sales activity which makes more sense to a sales representative and with which a reasonable success, including new client development, can be expected.

The sales activity support apparatus according to the present embodiment, wherein the arithmetic device may further execute processing to perform reinforcement learning by using, as learning data, part of the pieces of information on the organization and the sales activity and generate the prediction model for determining the KPI.

According to this, a KPI prediction model can be efficiently generated. By extension, it is possible to generate and present a recommended measure about a sales activity which makes more sense to a sales representative and with which a reasonable success, including new client development, can be expected.

The sales activity support method according to the present embodiment, wherein in the output of the policy value and the unweighted policy value, the information processing apparatus may generate a graph by plotting the policy value obtained for each organization on a coordinate system corresponding to the policy value and the unweighted policy value and may output the graph.

The sales activity support method according to the present embodiment, wherein the information processing apparatus may acquire pieces of information on a new sales target organization and on a sales activity for the new sales target organization, may perform the calculation of a predicted value of the KPI and the calculation of the weight for the new sales target organization, may perform the determination of each of the policy value and the unweighted policy value about the new sales target organization, and may output the policy value and the unweighted policy value obtained about the new sales target organization.

The sales activity support method according to the present embodiment, wherein the information processing apparatus may further execute processing to perform reinforcement learning by using, as learning data, part of the pieces of information on the organization and the sales activity and generate the prediction model for determining the KPI.

What is claimed is:

1. A sales activity support apparatus comprising:
a storage device configured to hold pieces of information on a sales target organization and a sales activity for the organization; and
an arithmetic device configured to execute
processing to calculate a predicted value of a KPI about the organization by applying information to a predetermined KPI prediction model obtained through learning based on part of the pieces of information, the information applied to the predetermined KPI prediction model being information in the pieces of information other than the part of the pieces of information,
processing to calculate a weight corresponding to a degree by which the predicted value exceeds a track record value related to the sales activity for the organization,
processing to generate a determination model for determining a policy value indicating direction of a sales activity related to the organization, the determination model being generated through learning based on the information on the organization as an explanatory variable, the KPI related to the sales activity for the organization, and the weight,
processing to determine the policy value by applying the information on the organization to the determination model,
processing to determine an unweighted policy value by applying the information on the organization to a determination model which is the determination model learned with no weight applied, and
processing to output the policy value and the unweighted policy value obtained about the organization.

2. The sales activity support apparatus according to claim 1, wherein
in the output of the policy value and the unweighted policy value, the arithmetic device generates a graph by plotting the policy value obtained for each organization on a coordinate system corresponding to the policy value and the unweighted policy value and outputs the graph.

3. The sales activity support apparatus according to claim 1, wherein
the arithmetic device acquires pieces of information on a new sales target organization and on a sales activity for the new sales target organization, performs the calculation of a predicted value of the KPI and the calculation of the weight for the new sales target organization, performs the determination of each of the policy value and the unweighted policy value about the new sales target organization, and outputs the policy value and the unweighted policy value obtained about the new sales target organization.

4. The sales activity support apparatus according to claim 1, wherein
the arithmetic device further executes processing to perform reinforcement learning by using, as learning data, part of the pieces of information on the organization and the sales activity and generate the prediction model for determining the KPI.

5. A sales activity support method implemented by an information processing apparatus, comprising:
holding, in a storage device, pieces of information on a sales target organization and a sales activity for the organization; and
executing
processing to calculate a predicted value of a KPI about the organization by applying information to a predetermined KPI prediction model obtained through learning based on part of the pieces of information, the information applied to the predetermined KPI prediction model being information in the pieces of information other than the part of the pieces of information,
processing to calculate a weight corresponding to a degree by which the predicted value exceeds a track record value related to the sales activity for the organization,
processing to generate a determination model for determining a policy value indicating direction of a sales activity related to the organization, the determination model being generated through learning based on the information on the organization as an explanatory variable, the KPI related to the sales activity for the organization, and the weight,
processing to determine the policy value by applying the information on the organization to the determination model,
processing to determine an unweighted policy value by applying the information on the organization to a determination model which is the determination model learned with no weight applied, and
processing to output the policy value and the unweighted policy value obtained about the organization.

6. The sales activity support method according to claim 5, wherein
in the output of the policy value and the unweighted policy value, the information processing apparatus generates a graph by plotting the policy value obtained for each organization on a coordinate system corresponding to the policy value and the unweighted policy value and outputs the graph.

7. The sales activity support method according to claim 5, wherein
the information processing apparatus acquires pieces of information on a new sales target organization and on a sales activity for the new sales target organization, performs the calculation of a predicted value of the KPI and the calculation of the weight for the new sales target organization, performs the determination of each of the policy value and the unweighted policy value about the new sales target organization, and outputs the policy value and the unweighted policy value obtained about the new sales target organization.

8. The sales activity support method according to claim 5, wherein
the information processing apparatus further executes processing to perform reinforcement learning by using, as learning data, part of the pieces of information on the organization and the sales activity and generate the prediction model for determining the KPI.
